(19) United States
(12) Patent Application Publication
(10) Pub. No.: US 2013/0187839 A1
(43) Pub. Date: Jul. 25, 2013

(54) ORGANIC LIGHT EMITTING DISPLAY DEVICES AND METHODS OF MANUFACTURING ORGANIC LIGHT EMITTING DISPLAY DEVICES

(71) Applicant: SAMSUNG DISPLAY CO., LTD, Yongin-City (KR)

(72) Inventors: Seung-Yo Yang, Yongin-City (KR); Do-Hyung Ryu, Yongin-City (KR)

(73) Assignee: SAMSUNG DISPLAY CO., LTD, Yongin-City (KR)

(21) Appl. No.: 13/656,052

(22) Filed: Oct. 19, 2012

(30) Foreign Application Priority Data
Jan. 19, 2012 (KR) 10-2012-0006073

(51) Int. Cl. G09G 3/30; H05B 33/10

(52) U.S. Cl. 345/76; 445/24

(57) ABSTRACT

An organic light emitting display device includes a first substrate, an organic light emitting structure, a peripheral circuit, a recess, a black matrix and a polarization structure. The first substrate may include a display region and a peripheral region. The peripheral region may surround the display region or extend along at least one side of the display region. The organic light emitting structure may be disposed over a first face of the first substrate in the display region. The peripheral circuit may be disposed over the first face of the first substrate in the peripheral region. The recess may be disposed on a second face of the first substrate in the peripheral region. The black matrix may be disposed in the recess. The polarization structure may be disposed over the black matrix and the second face of the first substrate.

### CROSS-REFERENCE TO RELATED APPLICATION

This application claims priority under 35 USC §119 to Korean Patent Application No. 10-2012-0006073 filed on Jan. 19, 2012 in the Korean Intellectual Property Office (KIPO), the contents of which are herein incorporated by reference in its entirety.

### BACKGROUND

1. Field

The present disclosure relates to organic light emitting display devices and methods of manufacturing organic light emitting display devices.

2. Related Technology

An organic light emitting display (OLED) device may display desired information such as images, letters and/or characters using light generated by combining holes provided from an anode with electrons provided from a cathode in an organic layer thereof. The OLED device may ensure relatively large view angle, rapid response speed, small thickness, low power consumption, etc. Accordingly the OLED device may be certainly expected to be one of the most prospecting next-generation display devices.

The OLED device may include a display region and a peripheral region. An organic light emitting display structure may be disposed in the display region and a peripheral circuit may be located in the peripheral region. To shield the peripheral circuit from a user, a frame or a light shielding layer may be disposed to cover the peripheral region. The foregoing discussion is to provide general background information, and does not constitute an admission of prior art.

### SUMMARY

When the light shielding layer such as a black matrix is disposed between a polarization film and a display panel, a gap or an air bubble may be generated therebetween due to a step between the black matrix and the substrate. Further, mechanical strength of the OLED device may also decrease. Thus, one aspect provides organic light emitting display devices ensuring improved mechanical strength and visibility.

Another aspect provides methods of manufacturing organic light emitting display devices having enhanced mechanical strength and visibility.

According to embodiments, there is provided an organic light emitting display device including a first substrate, an organic light emitting structure, a peripheral circuit portion, a recess, a black matrix and a polarization structure. The first substrate includes a display region and a peripheral region next to at least one side of the display region. The organic light emitting structure is disposed over a first face of the first substrate in the display region. The peripheral circuit portion is disposed over the first face of the first substrate in the peripheral region. The recess is disposed on a second face of the first substrate in the peripheral region, the second face being opposite to the first face. The black matrix is disposed in the recess. The polarization structure is disposed over the black matrix and the second face of the first substrate.

In embodiments, the recess may have a width of about 5 mm to about 15 mm. A ratio of a depth of the recess to the width of the recess may be about 1:250 to about 1:5,000. A depth of the recess may be substantially the same as a thickness of the black matrix.

In embodiments, the black matrix may include black silicon or carbon black.

In embodiments, the peripheral region may surround the display region.

In embodiments, the black matrix may have a size substantially the same as a size of the recess. A surface of the black matrix and the second face of the first substrate may be positioned on the same plane.

In embodiments, the black matrix may have a line shape, a bent line shape, a curve line shape, a “U” shape, a rectangular band shape, an elliptic band shape, a circular band shape and a polygonal band shape, etc., when viewed in a direction perpendicular to the second face.

In embodiments, the organic light emitting display device may further include a switching structure disposed between the first substrate and the organic light emitting structure in the display region. A second substrate may oppose the first substrate. A sealant may interconnect the first substrate and the second substrate.

According to embodiments, there is provided a method of manufacturing a polarization structure. In the method, a display panel having a display region and a peripheral region is provided. The display panel includes a first substrate, an organic light emitting structure disposed over a first face of the first substrate and a peripheral circuit disposed over the first face of the first substrate. The first substrate is partially removed to form a recess on a second face of the first substrate in the peripheral region. A black matrix is formed in the recess. A polarization structure is formed over the second face of the first substrate and the black matrix.

In embodiments, the peripheral region may be positioned next to at least one side of the display region.

In embodiments, the peripheral region may surround the display region.

In embodiments, the recess may have a width of about 5 mm to about 15 mm. A ratio of a depth of the recess to the width of the recess may be about 1:250 to about 1:5,000.

In embodiments, the black matrix may have a size substantially the same as a size of the recess. The black matrix may be formed to have a line shape, a bent line shape, a curved line shape, a “U” shape, a rectangular band shape, an elliptic band shape, a circular band shape and a polygonal band shape, etc. when viewed in a direction perpendicular to the second face. A surface of the black matrix and the second face of the first substrate may be located on the same plane.

In embodiments, the black matrix may be formed using black silicon or carbon black.

In embodiments, the first substrate may include a transparent ceramic substrate and forming the recess may include a dry etching process or a wet etching process.

In embodiments, the first substrate may include a transparent polymer substrate and forming the recess may include a polishing process.

According to embodiments, an organic light emitting display device may include a black matrix filling a recess which may be disposed on a first substrate in a peripheral region. The black matrix may serve as a light shielding layer, such that an additional frame or a bezel for shielding a peripheral circuit may be omitted. Additionally, a gap or an air bubble may not be generated between the first substrate and a polarization structure or between the black matrix and the polarization structure to thereby improve mechanical strength of the organic light emitting display device.

### BRIEF DESCRIPTION OF THE DRAWINGS

Embodiments will be more clearly understood from the following detailed description taken in conjunction with the accompanying drawings. FIGS. 1 to 8 represent non-limiting, embodiments as described herein.

FIG. 1 is a cross-sectional view illustrating an organic light emitting display device in accordance with embodiments;

FIG. 2 is a plan view illustrating a substrate having a black matrix in accordance with embodiments;

FIG. 3 is a cross-sectional view illustrating an organic light emitting display device in accordance with some embodiments;

FIG. 4 is a plan view illustrating a substrate having a black matrix in accordance with some embodiments; and

FIGS. 5 to 8 are cross-sectional views illustrating a method of manufacturing an organic light emitting display device in accordance with embodiments.

### DESCRIPTION OF EMBODIMENTS

Various embodiments will be described more fully hereinafter with reference to the accompanying drawings, in which some embodiments are shown. The invention may, however, be embodied in many different forms and should not be construed as limited to the embodiments set forth herein. Rather, these embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer; or intervening elements or layers may be present between the element or layer and the other element or layer. In contrast, when an element is referred to as being “directly on,” “directly connected to” or “directly coupled to” another element or layer, there are no intervening elements or layers, present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (for example, rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the face through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

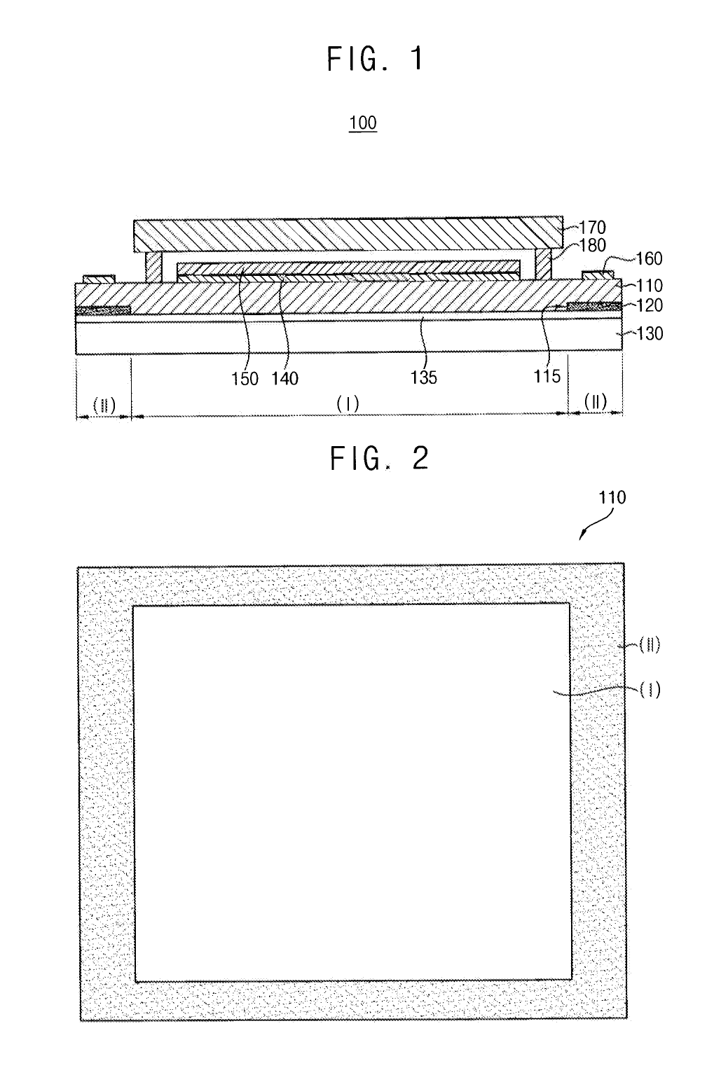

FIG. 1 is a cross-sectional view illustrating an organic light emitting display device in accordance with embodiments, and FIG. 2 is a plan view illustrating a substrate having a black matrix in accordance with embodiments.

Referring to FIG. 1, an organic light emitting display device 100 in accordance with embodiments may include a first substrate 110, a black matrix 120, a polarization structure 130, a switching structure 140, an organic light emitting structure 150, a peripheral circuit unit 160, a second substrate 170, a sealant 180, etc.

In embodiments, the switching structure 140, the organic light emitting structure 150 and the peripheral circuit unit 160 may be disposed between a first face of the first substrate 110 and the second substrate 170, and the black matrix 120 may be disposed between a second face of the first substrate 110 and the polarization structure 130. For example, when the organic light emitting display device 100 has a bottom emission type, the black matrix 120 may be positioned on the second face of the first substrate 110. Further, the switching structure 140, the organic light emitting structure 150 and the peripheral circuit unit 160 are disposed on the first face of the first substrate 110.

The first substrate 110 may include a transparent insulating substrate. For example, the first substrate 110 may include one of a glass substrate, a quartz substrate, a transparent resin substrate, etc. In some embodiments, the first substrate 110 may include a flexible substrate.

Referring to FIG. 2, the first substrate 110 may include a display region I and a peripheral region II which may substantially surround or enclose the display region I. For example, the peripheral region II may extend throughout four sides of the display region I to surround the display region I. An organic light emitting structure 150 may be positioned in the display region I, and the peripheral circuit unit 160 including a peripheral circuit may be positioned in the peripheral region II.

A recess 115 may be positioned on the second face of the first substrate 110 in the peripheral region II. In embodiments, the recess 115 may entirely cover the peripheral region II or may be formed throughout the peripheral region II. In some embodiments, the recess 115 may substantially cover at least a portion of the peripheral region II. For example, the recess 115 may have one of various shapes such as substantially a rectangular band shape, a substantially elliptic band shape, a substantially circular band shape, a substantially polygonal band shape, etc. when viewed in a direction perpendicular to the second face. The recess 115 may have a depth in a range of about 5 μm to about 20 μm when measured from the second face of the first substrate 110. Therefore, a step portion may be generated on the first substrate 110 between the display region I and the peripheral region II. Additionally, the recess 115 may have a width of about 5 mm to about 15 mm. Therefore, a ratio of the depth to the width of the recess 115 may be in a range of about 1:250 to about 1:5,000.

The black matrix 120 may be disposed in the recess 115. For example, the black matrix 120 may include black silicon, carbon black, etc. In embodiments, the black matrix 120 may have a height substantially the same as the depth of the recess 115. The black matrix 120 may substantially fill the recess 115, and thus the second face of the first substrate 110 and a face of the black matrix 120 may form a substantially flat face. That is, a step may not be formed between the second face of the first substrate 110 and the face of the black matrix 120. In embodiments, the black matrix 120 may entirely fill the recess 115, such that the black matrix 120 may have a width in a range of about 5 mm to about 15 mm. Therefore, a ratio of the height to the width of the black matrix may be about 1:250 to about 1:5,000. That is, the black matrix 120 may have a size substantially the same as or substantially similar to that of the recess 115. In an alternative embodiment, the black matrix 120 may have a height smaller than the depth of the recess 115.

Referring to FIG. 1, the polarization structure 130 may be disposed on the second face of the first substrate 110 and the face of the black matrix 120. The polarization structure 130 may be located on a substantially level face formed by the first substrate 110 and the black matrix 120 so that a gap or an air bubble may not be generated between the first substrate 110 and the polarization structure 130 or between the black matrix 120 and the polarization structure 130.

In embodiments, the polarization structure 130 may include at least one polarizing layer, a retardation layer, a protection layer, a plurality of adhesive layers, etc. The adhesive layers may include an adhesive layer 135 positioned on the second face of the first substrate 110 and on the face of the black matrix 120. The adhesive layer 135 may include a pressure sensitive adhesive. The polarization structure 130 may reduce or prevent a reflection of an external light to thereby improve a visibility of the organic light emitting display device 100.

When the organic light emitting display device 100 has an active matrix type, the organic light emitting display device 100 may include the switching structure 140 disposed on the first face of the first substrate 110 in the display region I. For example, the switching structure 140 may include a switching element such as a transistor and a plurality of insulation layers.

When the switching element includes a thin film transistor, the switching element may include a gate electrode, a source electrode, a drain electrode, and an active layer.

The organic light emitting structure 150 may be disposed on the switching structure 140 in the display region I. The organic light emitting structure 150 may include a plurality of organic layers. For example, the organic light emitting structure 150 may include a hole transfer layer, an organic light emitting layer, an electron transfer layer, etc., and the organic light emitting layer may include an organic material or a mixture of an organic material and an inorganic material generating at least one of a red color of light, a green color of light and a blue color of light.

The peripheral circuit unit 160 may be disposed on the first substrate 110 in the peripheral region II. For example, the peripheral circuit unit 160 may include various peripheral circuits such as a gate driving circuit, a data driving circuit, common power supply lines and a driving power supply line. The peripheral circuits may receive a signal from an external portion, and may transfer the signal to the organic light emitting structure 150. In embodiments, the peripheral circuit unit 160 may be disposed to sufficiently cover the peripheral region II. In some embodiments, the peripheral circuit unit 160 may be positioned to substantially surround or enclose the display region I.

Referring now to FIG. 1, the second substrate 170 may be positioned above the first substrate 110. That is, the second substrate 170 may substantially oppose the first substrate 110. The second substrate 170 may include a transparent insulating substrate or an opaque insulating substrate. For example, the second substrate 170 may include the transparent insulating substrate such as a glass substrate, a quartz substrate, a transparent resin substrate, etc. Alternatively, the second substrate 170 may include the opaque insulating substrate such as a metal substrate, a metal oxide substrate, etc.

The sealant 180 may be disposed between the first substrate 110 and the second substrate 170 to combine or interconnect the first substrate 110 and the second substrate 170. Therefore, the sealant 180 may prevent water vapor or contaminants from penetrating into the organic light emitting structure 150, which may avoid a degradation of the organic layers in the organic light emitting structure 150.

Although the organic light emitting display device 100 may have a bottom emission type as illustrated in FIG. 1, the invention may not be limited to the above-described construction. That is, the organic light emitting display device may have a top emission type.

In embodiments, the organic light emitting display device 100 may include the black matrix 120 filling the recess 115 disposed on the second face of the first substrate 110 in the peripheral region II. The black matrix 120 may serve as a light shielding layer, such that the black matrix 120 may shield the peripheral circuit unit 160. Therefore, an additional frame or an additional bezel for shielding the peripheral circuit unit 160 may be omitted. Additionally, the black matrix 120 may be positioned in the recess 115 of the first substrate 110 to prevent a gap or an air bubble from generating between the first substrate 110 and the polarization structure 130 or between the black matrix 120 and the polarization structure 130. Accordingly, the mechanical strength of the organic light emitting display device 100 may be enhanced while a decrease in the visibility of the images may be reduced.

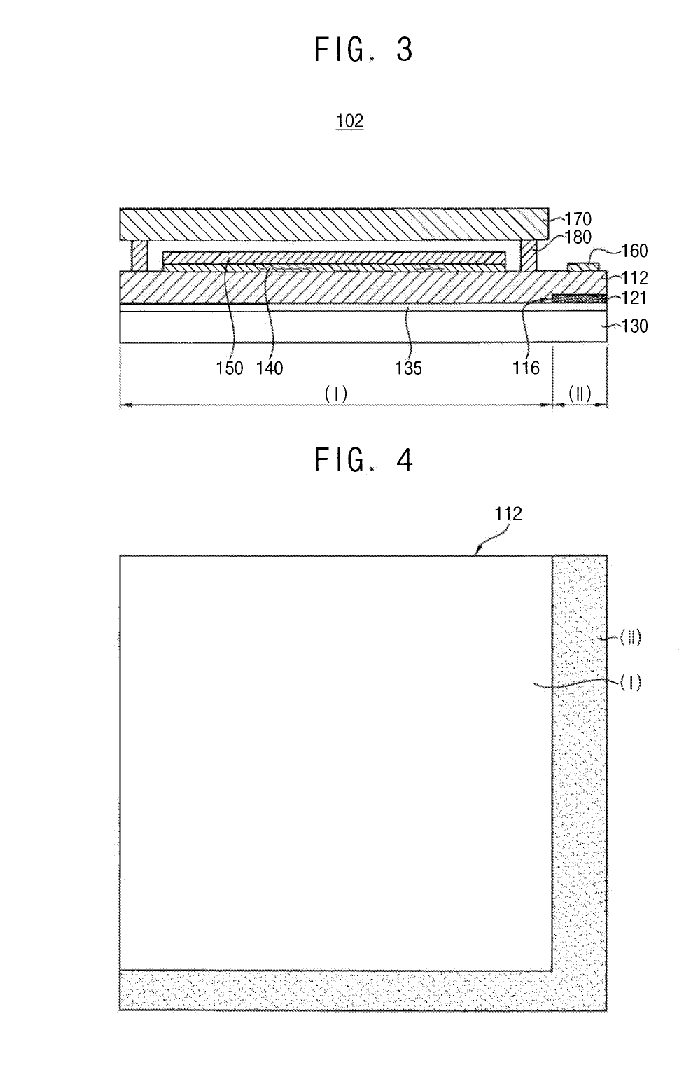

FIG. 3 is a cross-sectional view illustrating an organic light emitting display device in accordance with some embodiments, and FIG. 4 is a plan view illustrating a substrate having a black matrix in accordance with some embodiments.

Referring to FIG. 3, an organic light emitting display device 102 may include a first substrate 112, a black matrix 121, a polarization structure 130, a switching structure 140, an organic light emitting structure 150, a peripheral circuit portion 160, a second substrate 170, a sealant 180, etc. The polarization structure 130, the switching structure 140, the organic light emitting structure 150, the peripheral circuit portion 160, the second substrate 170 and the sealant 180 illustrated in FIG. 3 may be substantially the same as or substantially similar to the polarization structure 130, the switching structure 140, the organic light emitting structure 150, the peripheral circuit portion 160, the second substrate 170 and the sealant 180 described with reference to FIG. 1, respectively. Thus, for brevity detailed description thereof may be simplified or omitted.

Referring to FIG. 3 and FIG. 4, the first substrate 112 may include a transparent insulating substrate. The first substrate may include a display region I and a peripheral region II which may be disposed next to at least one side of the display region I. Although the peripheral region II may be positioned adjacent to a lower side and a right side of the display region I as illustrated in FIG. 4, in alternative embodiment, the peripheral region II also may be positioned adjacent to one of an upper side, a left side, the lower side and the right side of the display region I. In other embodiments, the peripheral region II may be positioned adjacent to two or three sides among an upper side, a left side, the lower side and the right side of the display region I. In embodiments illustrated in FIG. 4, the peripheral region II extends along the entire lengths of the lower and right sides. Alternatively, the peripheral region II may extend along a portion of the length of a side of the display region I. The organic light emitting structure 150 may be disposed in the display region I, and the peripheral circuit unit 160 may be disposed in the peripheral region II.

Referring to FIG. 3, the recess 116 may be formed on a second face of the first substrate 112 in the peripheral region II. Thus, the recess 116 may be positioned next or adjacent to at least one side of the display region I. As described above, the recess 116 may be positioned adjacent to one, two or three of the upper side, the lower side, the right side and the left side of the display region I.

The black matrix 121 may fill the recess 116 to be positioned next to and substantially extend along at least one of the upper side, the lower side, the right side and the left side of the display region I. Therefore, the black matrix 121 may have various shapes such as a substantially bent line shape, a curved line shape, a substantially “U” shape, etc. when viewed in a direction perpendicular to the second face. In embodiments, the black matrix 121 may have a thickness substantially the same as a depth of the recess 116. That is, the black matrix 121 may have a size substantially the same as or substantially similar to a size of the recess 116.

The polarization structure 130 may be disposed on a second face of the first substrate 112 and the black matrix 121. As described above, a gap or an air bubble may not be generated between the polarization structure 130 and the first substrate 112 or between the polarization structure 130 and the black matrix 121.

In embodiments, the organic light emitting display, device 102 may include the black matrix 121 filling the recess 116 which may be disposed on the second face of the first substrate 112 in the peripheral region II. In comparison with the organic light emitting display device 100 described with reference to FIG. 1, the organic light emitting display device 102 described with reference to FIG. 3 may include the black matrix 121 that may partially extend along the sides of the display region I. In this case, an additional frame or an additional bezel for shielding the peripheral circuit unit 160 may be omitted, and a gap or an air bubble may not be occurred between the first substrate 112 and the polarization structure 130 or between the black matrix 121 and the polarization structure 130.

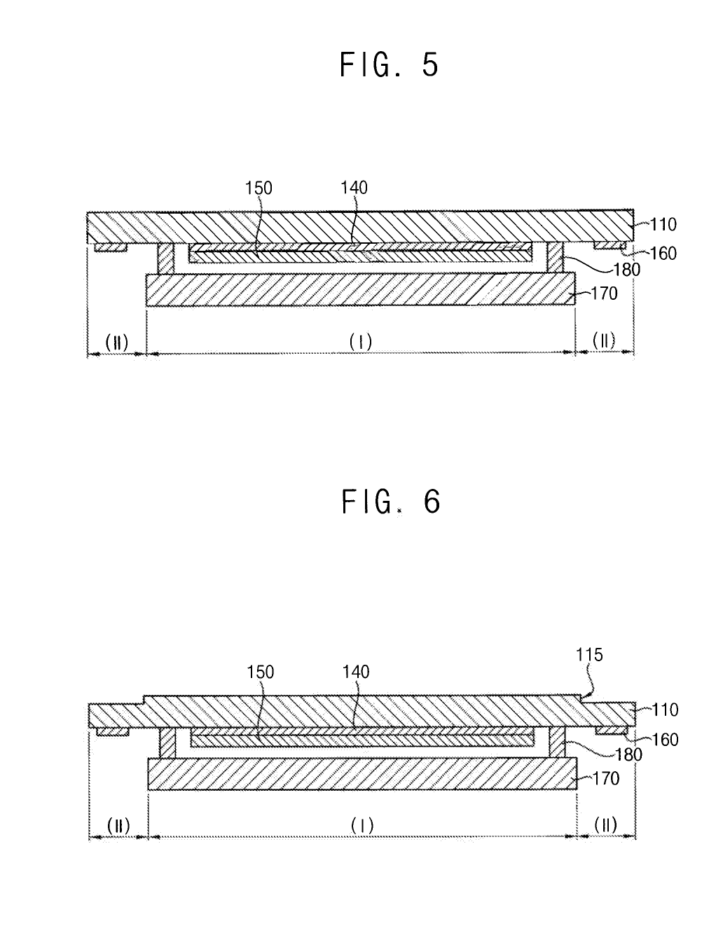

FIGS. 5 to 8 are cross-sectional views illustrating a method of manufacturing an organic light emitting display device in accordance with embodiments.

Referring to FIG. 5, a first substrate 110 having a display region I and a peripheral region II may be provided. As illustrated in FIGS. 2 and 4, the peripheral region II may contact at least one side of the display region I.

In embodiments, a switching structure 140 and an organic light emitting structure 150 may be sequentially formed on a first face of the first substrate 110 in the display region I, and a peripheral circuit unit 160 may be formed on the first face of the first substrate 110 in the peripheral region II. A second substrate 170 may be disposed above the first substrate 110 to oppose the first face of the first substrate 110, and the first substrate 110 and the second substrate 170 may be fixed by using a sealant 180 to complete a display panel of the organic light emitting display device.

Referring to FIG. 6, a portion of the first substrate 110 may be removed to form a recess 115 on a second face of the first substrate 110.

In embodiments, the recess 115 may be formed in the peripheral region II that may contact at least one side of the display region I. In this case, the recess 115 may have one of various shapes such as a substantially line shape, a substantially bent line shape, a curved line shape, a substantially “U” shape, etc. In some embodiments, the recess 115 may be formed in the peripheral region II that may entirely surround or enclose the four sides of the display region I. In this case, the recess 115 may have various planar shapes such as a substantially rectangular band shape, a substantially elliptic band shape, a substantially circular band shape, a substantially polygonal band shape, etc.

When the first substrate 110 includes a transparent ceramic substrate such as a glass substrate or a quartz substrate, the recess 115 may be formed by a dry etching process or a wet etching process. In embodiments, a photoresist pattern or a hard mask may be formed on the second face of the first substrate 110, and the first substrate 110 may be partially etched using the photoresist pattern or the hard mask to form the recess 115 in the peripheral region II.

When the first substrate 110 includes a transparent polymer substrate, the recess 115 may be formed by a dry etching process, a wet etching process or a polishing process. The first substrate 110 including the transparent polymer substrate may have mechanical strength substantially lower than the first substrate 110 including the transparent ceramic substrate. Therefore, the recess 115 may be formed in the peripheral region II by performing the polishing process as well as the etching process.

The recess 115 may be formed to have a width substantially the same as that of the peripheral region II. For example, the recess 115 may have a width of about 5 mm to about 15 mm. The recess 115 may have a depth in a range of about 5 μm to about 15 μm, so that a ratio of the depth to the width of the recess 115 may be about 1:250 to about 1:5,000.

In embodiments, a sidewall of the recess 115 may be substantially perpendicular to the second face of the first substrate 110. In some embodiments, a sidewall of the recess 115 may have a predetermined angle with respect to the second face of the first substrate 110. That is, the recess 115 may have the sidewall inclined by the predetermined angle with respect to the substrate 100.

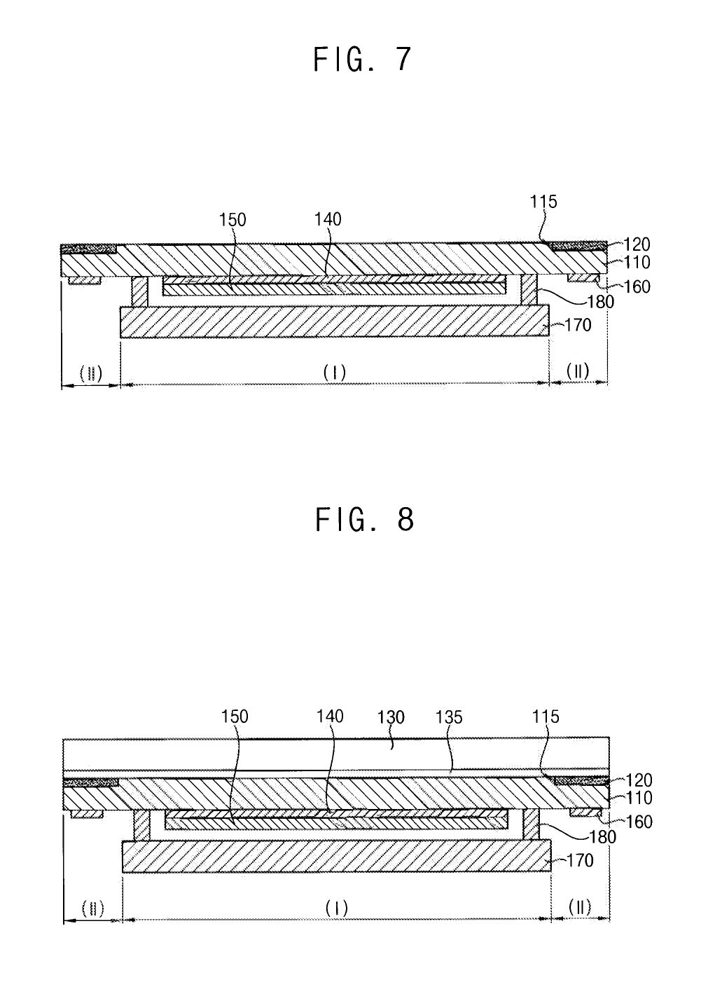

Referring to FIG. 7, a black matrix 120 may be formed in the recess 115.

In embodiments, the black matrix 120 may be formed by an ultraviolet (UV) ink printing process. For example, the black matrix 120 may be formed by filling the recess 115 with a black ultraviolet (UV) ink, and irradiating a light having a predetermined wavelength to harden the black UV ink. In this case, the black matrix 120 may be formed to have various planar shapes such as a substantially line shape, a substantially bent line shape, a curved line shape, a substantially “U” shape, a substantially rectangular band shape, a substantially elliptic band shape, a substantially circular band shape, a substantially polygonal band shape, etc. For example, the black UV ink may include black silicon or carbon black. The UV ink printing process may be performed at a relatively low temperature, such that the display panel may not have thermal damages while forming the black matrix 120 in the recess 115. Alternatively, the black matrix 120 may be formed by a spray printing process.

The black matrix 120 may be formed to have a size substantially the same as or substantially similar to that of the recess 115. Accordingly, a step may not be formed between the exposed face of the black matrix 120 and the second face of the first substrate 110.

Referring to FIG. 8, a polarization structure 130 may be formed on the second face of the first substrate 110 and the black matrix 120.

In embodiments, an adhesive layer 135 of the polarization structure 130 may be formed adjacent to the second face of the first substrate 110. The adhesive layer 135 may include a pressure sensitive adhesive, so that the polarization structure 130 may adhere to the first substrate 110 and the black matrix when a pressure is applied to the adhesive layer 135. Accordingly, the organic light emitting display device may be completed.

According to embodiments of the method of manufacturing the organic light emitting display device, the step may not be formed between the second face of the first substrate 110 and the exposed face of the black matrix 120. Therefore, the polarization structure 130 may adhere to the first substrate 110 without forming the gap or the air bubble therebetween. Additionally, the black matrix 120 may be formed at a relatively low temperature using the ultraviolet (UV) ink printing process without causing damaging to the display panel.

According to embodiments, a gap or an air bubble may not be formed between the first substrate and a polarization structure or between the black matrix and the polarization structure. Therefore, the mechanical strength and the visibility of the organic light emitting display device may be improved. The organic light emitting display device according to embodiments may be employed in general display apparatuses and various recent electronic apparatuses such as e-books, customer products, etc.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. An organic light emitting display device, comprising:
a first substrate comprising a display region and a peripheral region next to at least one side of the display region;
an organic light emitting structure disposed over a first face of the first substrate in the display region;
a peripheral circuit portion disposed over the first face of the first substrate in the peripheral region;
a recess disposed on a second face of the first substrate in the peripheral region, the second face being opposite to the first face;
a black matrix disposed in the recess; and
a polarization structure disposed over the black matrix and the second face of the first substrate.

2. The organic light emitting display device of claim 1, wherein the recess has a width of about 5 mm to about 15 mm, wherein a ratio of a depth of the recess to the width of the recess is about 1:250 to about 1:5,000.

3. The organic light emitting display device of claim 1, wherein a depth of the recess is substantially the same as a thickness of the black matrix.

4. The organic light emitting display device of claim 1, wherein the black matrix includes black silicon or carbon black.

5. The organic light emitting display device of claim 1, wherein the peripheral region surrounds the display region.

6. The organic light emitting display device of claim 1, wherein the black matrix has a size substantially the same as that of the recess.

7. The organic light emitting display device of claim 6, wherein a surface of the black matrix and the second face of the first substrate are positioned on the same plane.

8. The organic light emitting display device of claim 6, wherein the black matrix has one selected from the group consisting of a line shape, a bent line shape, a curved line shape, a “U” shape, a rectangular band shape, an elliptic band shape, a circular band shape and a polygonal band shape when viewed in a direction perpendicular to the second face.

9. The organic light emitting display device of claim 1, further comprising:
a switching structure disposed between the first substrate and the organic light emitting structure in the display region;
a second substrate opposing the first substrate; and
a sealant interconnecting the first substrate and the second substrate.

10. A method of manufacturing an organic light emitting display device, comprising:
providing a display panel comprising a first substrate, an organic light emitting structure disposed over a first face of the first substrate and a peripheral circuit disposed over the first face of the first substrate, the display panel having a display region and a peripheral region;
partially removing the first substrate to form a recess on a second face of the first substrate in the peripheral region;
forming a black matrix in the recess; and
forming a polarization structure over the second face of the first substrate and the black matrix.

11. The method of claim 10, wherein the peripheral region is positioned next to at least one side of the display region.

12. The method of claim 11, wherein the peripheral region surrounds the display region.

13. The method of claim 10, wherein the recess has a width of about 5 mm to about 15 mm, wherein a ratio of a depth of the recess to the width of the recess is about 1:250 to about 1:5,000.

14. The method of claim 10, wherein the black matrix has a size substantially the same as that of the recess.

15. The method of claim 10, wherein the black matrix is formed to have one selected from the group consisting of a line shape, a bent line shape, a curved line shape, a “U” shape, a rectangular band shape, an elliptic band shape, a circular band shape and a polygonal band shape when viewed in a direction perpendicular to the second face.

16. The method of claim 14, wherein the black matrix is formed using black silicon or carbon black.

17. The method of claim 10, wherein the first substrate comprises a transparent ceramic substrate, wherein the recess is formed by using a dry etching process or a wet etching process.

18. The method of claim 10, wherein the first substrate comprises a transparent polymer substrate, wherein the recess is formed by using a polishing process.

19. The method of claim 10, wherein a surface of the black matrix and the second face of the first substrate are located on the same plane.
